(19) United States
(12) Patent Application Publication
(10) Pub. No.: US 2020/0125918 A1
(43) Pub. Date: Apr. 23, 2020

(54) Counting apparatus on ceramic chip assembly line

(71) Applicant: Cuifang Yang, Fuzhou City (CN)

(72) Inventor: Cuifang Yang, Fuzhou City (CN)

(21) Appl. No.: 16/718,196

(22) Filed: Dec. 18, 2019

(30) Foreign Application Priority Data
Sep. 19, 2019 (CN) 2019108857646

(51) Int. Cl. G06M 1/06; G06M 1/02; G06M 1/10

(52) U.S. Cl. CPC G06M 1/06; G06M 1/107; G06M 1/02

(57) ABSTRACT

The invention discloses a counting device on a ceramic chip assembly line. The casing is provided with a counting cavity therein, the counting cavity is provided with a left-side opening transmission cavity on the upper side, and the counting chamber is provided with an inner wall on the upper side. The working table of the present invention adopts a ball design to ensure that the position of the ceramic sheet meets the requirements when entering. The design of the push rod and ratchet is used to judge the placement of the ceramic sheet. A unidirectional bearing is used to perform rotation in different directions. Screening, so that only one motor is used as the power source, saving components, using the intermittent cooperation between components, implementing the counting function for the single, ten, and hundreds digits, using the design of cables and coil springs.

### CROSS-REFERENCES TO RELATED APPLICATIONS

The present application claims priority from Chinese application No. 2019108857646 filed on Sep. 19, 2019 which is hereby incorporated by reference in its entirety.

### FIELD OF TECHNOLOGY

The invention relates to the technical field of ceramic chip counting, and in particular relates to a counting apparatus on ceramic chip assembly line.

### TECHNICAL FIELD

The ceramic chip assembly line refers to the automatic production method dedicated to the production of ceramic chips, which has been popularized by various ceramic chip manufacturers. Generally, the number of ceramic pieces produced can be compared with the preset output, the health of the ceramic piece assembly line can be evaluated from a certain angle, and the maintenance and maintenance plan of the ceramic piece assembly line can be finally formulated. However, most of the current methods for counting the number of ceramic pieces are manually evaluated, which not only consumes a lot of effort, but also has a large error in statistical data. The present invention illustrates a device capable of solving the above problems.

### CONTENT OF THE INVENTION

### Technical Problem

However, most of the current methods for counting the number of ceramic pieces are manually evaluated, which not only consumes a lot of effort, but also has a large error in statistical data.

In order to solve the above problem, a counting device on a ceramic chip assembly line is designed in this example. The counting device includes a casing, the casing is provided with a counting cavity, and the upper side of the counting cavity is provided with a left-opening transmission cavity. A working table is provided on the inner wall of the upper side of the cavity. The working table is provided with a lifting mechanism. The lifting mechanism includes a slider slidingly connected to the table, and an inclined table provided on the slider. A first transmission shaft is rotatably connected to the lower side of the block, a cable is provided on the first transmission shaft, a one-way bearing located on a front side of the cable is provided on the first transmission shaft, and a rear wall of the counting cavity is provided. A second transmission shaft located below the first transmission shaft is connected with the upper rotation, and a determination component is provided on the rear wall of the counting cavity. The determination component includes a motor provided on the rear wall of the counting cavity, and the power is connected to The disk of the second transmission shaft, the ratchet teeth provided on the disk, the counting rod provided on the counting disk and abutting with the ratchet teeth, and the back wall of the counting cavity is rotatably connected. There is a transmission shaft on the left side of the first transmission shaft, and the counting cavity A third transmission shaft located on the left side of the transmission shaft is rotatably connected to the wall, and a fourth transmission shaft located on the left side of the third transmission shaft is rotatably connected to the rear wall of the counting cavity, and the back wall of the counting cavity is rotatably connected. A fifth transmission shaft located on the left side of the fourth transmission shaft is rotatably connected. The transmission shaft is provided with a first auxiliary pulley, and the first auxiliary pulley is provided with a counting component. The counting component includes a setting. A toothed plate on the first auxiliary pulley, a ten-position gear provided on the third transmission shaft and meshable with the toothed plate, provided on the fourth transmission shaft and connectable with A gear engaged with the ten-position gear, a dot disposed on the gear, a sheave disposed on the fifth transmission shaft and slidably connected to the dot, and a lower wall of the counting cavity is provided The resetting device is located on the lower wall of the counting chamber, and a transmission component is located on the right side of the resetting device. A sequencing component is provided on the rear wall of the transfer cavity. A fifth transmission shaft rotationally connected to the rear wall of the transmission cavity is provided on the fifth transmission shaft Transfer wheel, the groove is provided for storing the transfer wheel.

Preferably, an elastic belt is connected between the first auxiliary pulley and the one-way bearing, a first main pulley is provided at the front end of the second transmission shaft, and a sixth is rotatably connected to the rear wall. A transmission shaft, a first bevel gear is provided at the front end of the sixth transmission shaft, a seventh transmission shaft is rotatably connected to the rear wall of the transmission cavity, and a second bevel gear is provided at the front end of the seventh transmission shaft, The right inner wall of the conveying cavity is provided with an entrance track for the ceramic sheet to enter, the front wall of the counting cavity is provided with three display through holes, and the device is provided with two counter dials for counting counterclockwise, one provided in the A third end of the front end of the third transmission shaft is located on the fifth transmission shaft, and a number disc for counting clockwise is provided on the end of the front end of the first transmission shaft.

Wherein, the lifting mechanism further includes springs which are symmetrically arranged on the lower side of the inclined platform and are connected to the worktable.

Wherein, the one-way bearing includes a bearing box rotatably connected to the first transmission shaft, the bearing box is provided with a rotation cavity, and the rotation cavity is provided with a roller fixedly connected to the first transmission shaft. The roller is provided with six bearing ratchets distributed in an array, six thrust rods distributed in an array are rotatably connected to the bearing box, and a bearing spring is connected between the thrust rod and the bearing box.

Wherein, the determination component further includes a long rod provided on the cable, a horizontal bracket is provided at the right end of the slider, and a counting spring is connected between the horizontal bracket and the long rod.

Wherein, the counting component further includes a semilunar wheel which is arranged on the round point and can be rotatably connected with the groove wheel, and the groove wheel is provided with a transmission groove which can be slidably connected with the round point.

Preferably, when the counting lever is in contact with the ratchet teeth, the ratchet teeth can drive the counting lever to rotate thirty-six degrees.

Wherein, the resetting device includes a resetting housing provided on the lower wall of the counting cavity, a resetting cavity is provided in the resetting housing, a bracket is provided on the right wall of the resetting cavity, and a resetting volume is provided on the bracket. A spool is provided between the reset spool and the right wall of the reset cavity. A reset slideway is provided on the left inner wall of the counting cavity, and a reset lever is slidably connected to the reset slideway. A lever is rotatably connected to the upper inner wall of the reset cavity, a reset spring is connected between the lever and the upper inner wall of the reset cavity, and a lever is rotatably connected to the reset lever.

Wherein, the transmission assembly includes an eighth transmission shaft rotatably connected to the back wall of the counting cavity, and the eighth transmission shaft is provided with a second auxiliary pulley, and the second auxiliary pulley is connected to the first main shaft. A motor belt is connected between the pulleys. The eighth transmission shaft is provided with a third bevel gear located behind the second auxiliary pulley. A ninth transmission shaft is rotatably connected to the inner wall of the lower side of the counting chamber. The ninth transmission shaft is provided with a fourth bevel gear meshed with the third bevel gear, and the ninth transmission shaft is provided with a second main pulley located on the upper side of the fourth bevel gear. A fifth bevel gear meshed with the first bevel gear is provided on the ninth transmission shaft, and a tenth transmission shaft is rotatably connected to the inner wall of the lower side of the counting cavity. A sixth bevel gear that is in meshing connection with the second bevel gear, a third auxiliary pulley located below the sixth bevel gear is provided on the tenth transmission shaft, and the third auxiliary pulley is in contact with the first auxiliary pulley. A belt is connected between the two main pulleys.

The sequencing component further includes an eleventh transmission shaft that is rotatably connected to the rear wall of the transfer cavity. The eleventh transmission shaft is provided with a fourth auxiliary pulley, and the seventh transmission shaft is provided with A third main pulley, a transmission belt is connected between the fourth auxiliary pulley and the third main pulley, and a guide track flush with the transmission belt is provided on the rear wall of the transmission cavity; Twenty-two ball tracks are symmetrically arranged in the guide track, and the ball tracks are provided with rotatable balls.

The beneficial effects of the present invention are: the present invention adopts a ball design to ensure that the position of the ceramic sheet meets the requirements when entering, uses a push rod and ratchet design to judge the placement of the ceramic sheet, and uses a one-way bearing to The direction of rotation is screened, so that only one motor is used as the power source, which saves components, adopts the intermittent cooperation between components, and realizes the counting function of singles, tens, and hundreds, using cables and coils. The design of the spring guarantees the function of numerical reset after the work is completed, and improves most of the current methods of counting the number of ceramic pieces are manually evaluated, which not only requires a lot of effort, but also has a large error in the statistical data.

### BRIEF DESCRIPTION OF THE DRAWINGS

For ease of description, the present invention is described in detail by the following specific embodiments and the accompanying drawings.

FIG. 1 is a schematic diagram of the overall structure of a counting device on a ceramic chip assembly line according to the present invention;

FIG. 2 is a schematic structural diagram of the direction “A-A” of FIG. 1;

FIG. 3 is a schematic structural diagram in a direction “B-B” of FIG. 1;

FIG. 4 is a schematic structural diagram in a direction “C-C” of FIG. 1;

FIG. 5 is a schematic structural diagram of the one-way bearing of FIG. 1;

FIG. 6 is a schematic structural diagram of the “E-E” direction of FIG. 1;

FIG. 7 is a schematic diagram of the structure of the digital disk and the display through hole in FIG. 1.

### DETAILED DESCRIPTION OF THE INVENTION

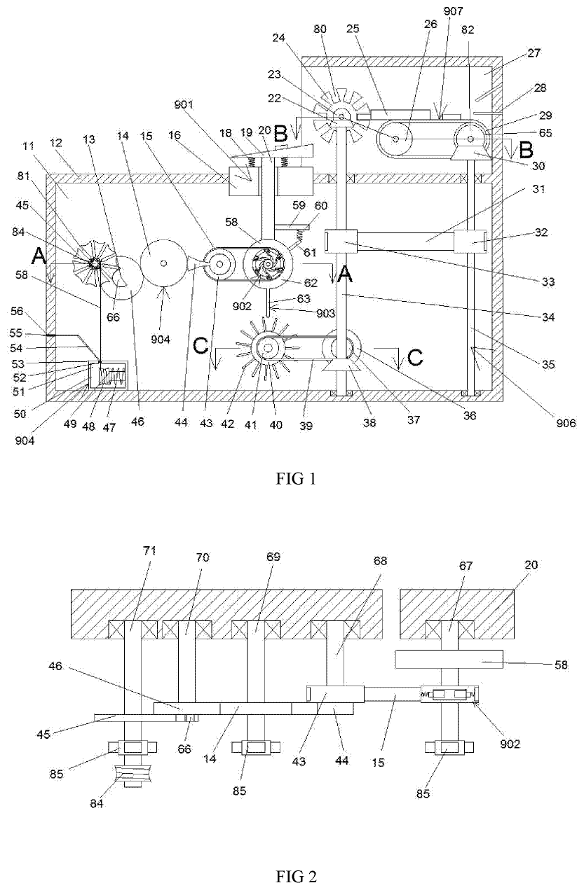

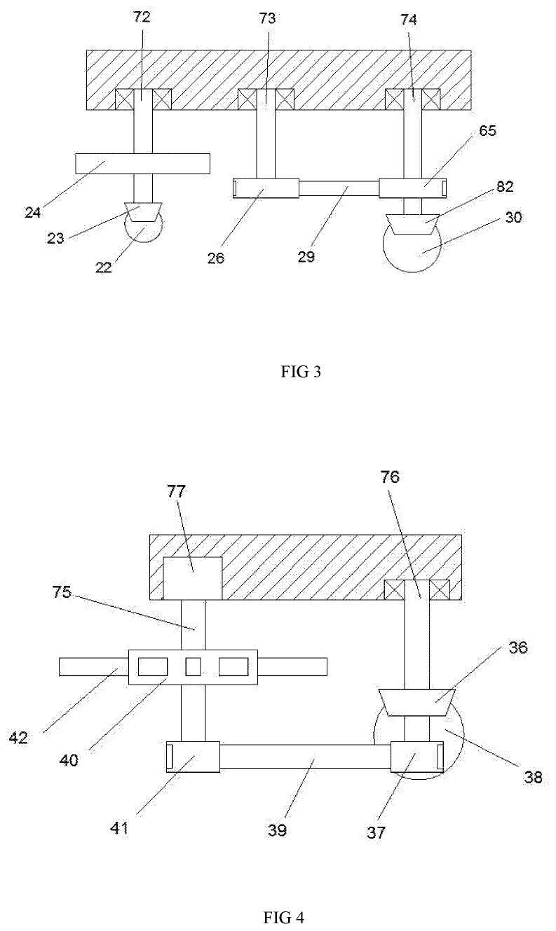

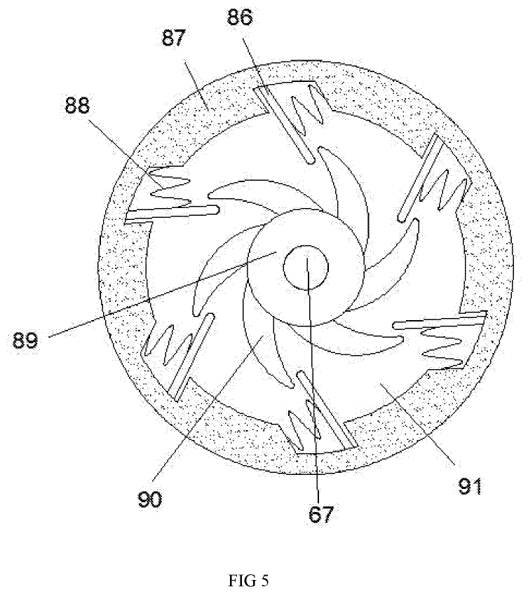

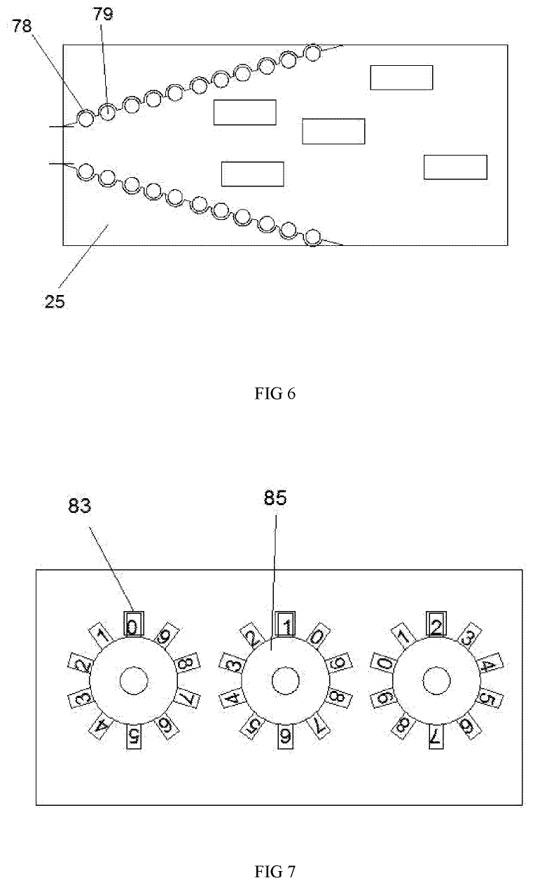

The present invention is described in detail below with reference to FIGS. 1 to 7. For convenience of description, the orientation described below is defined as follows: the up-down, left-right, front-back direction described below is consistent with the up-down, left-right, front-back direction of the projection relationship of FIG.

The invention relates to a counting device on a ceramic chip assembly line, which is mainly used in an automatic counting process on a ceramic chip production line. The invention will be further described below with reference to the accompanying drawings of the present invention:

A counting device on a ceramic chip assembly line according to the present invention includes a housing 12. The housing 12 is provided with a counting chamber 11. The counting chamber 11 is provided with a transmission chamber 27 opened on the left side. A working table 16 is provided on the upper inner wall of the counting chamber 11, and a lifting mechanism 901 is provided on the working table 16. The lifting mechanism 901 includes a slider 20 slidably connected to the working table 16 and is provided on the sliding device 20. The inclined table 19 on the block 20 is moved up and down by the gravity change caused by the ceramic plate of the inclined table 19. A first transmission shaft 67 is rotatably connected to the lower side of the slider 20, and the first transmission shaft 67 is provided on the A cable 58 is provided. The first transmission shaft 67 is provided with a one-way bearing 902 located on the front side of the cable 58. A rear wall of the counting cavity 11 is rotatably connected to the lower side of the first transmission shaft 67. The second transmission shaft 75 is provided with a judging component 903 on the rear wall of the counting cavity 11, and the judging component 903 includes a motor 77 provided on the rear wall of the counting cavity 11, and the power is connected to the second transmission shaft 75. Disk 40, ratchet teeth 42 provided on the disk 40, and the counting disk 62, The counting lever 63 abutting on the tooth 42 drives the one-way bearing 902 to rotate by whether the counting lever 63 abuts against the ratchet tooth 42 and realizes a judgment function. A transmission shaft 68 on the left side of the transmission shaft 67, a third transmission shaft 69 on the left side of the transmission shaft 68 is rotatably connected to the back wall of the counting chamber 11, and a rotation shaft 68 on the back wall of the counting chamber 11 is rotatably connected to the A fourth drive shaft 70 on the left side of the third drive shaft 69, a fifth drive shaft 71 on the left side of the fourth drive shaft 70 is rotatably connected to the rear wall of the counting chamber 11, and the drive shaft 68 is provided with The first auxiliary pulley 43 is provided with a counting component 904. The counting component 904 includes a toothed plate 44 provided on the first auxiliary pulley 43 and the first auxiliary pulley 43. A ten-position gear 14 on the three transmission shafts 69 that can be meshed with the toothed plate 44, a gear 46 that is disposed on the fourth transmission shaft 70 and can be meshed with the ten-position gear 14, and The dots 13 on the gear 46 and the sheaves 45 provided on the fifth transmission shaft 71 and slidably connected to the dots 13 communicate with each other. The rotation of the toothed plate 44, the intermittent transmission of the toothed plate 44 and the ten-position gear 14, and the intermittent transmission of the dot 13 and the sheave 45 realize the counting function of one, ten, and hundreds. The lower wall of the counting chamber 11 is provided with the reset device 905, the lower wall of the counting chamber 11 is provided with a transmission assembly 906 located on the right side of the reset device 905, and the rear wall of the transmission chamber 27 is provided with There is a sequence component 907, and the sequence component 907 can be connected to the rear wall of the transmission cavity 27 through a fifth transmission shaft 71, and a transmission wheel 24 disposed on the fifth transmission shaft 71 is disposed on the fifth transmission shaft 71. The storage slot 80 on the transmission wheel 24 ensures the stability and order when the ceramic sheet enters.

Advantageously, an elastic belt 15 is connected between the first auxiliary pulley 43 and the one-way bearing 902, and a first main pulley 41 is provided at the front end of the second transmission shaft 75, and the rear wall of the 27 is A sixth transmission shaft 72 is rotatably connected, and a first bevel gear 23 is provided at the front end of the sixth transmission shaft 72. A seventh transmission shaft 74 is rotatably connected to the rear wall of the transmission cavity 27. A second bevel gear 82 is provided at the front end of the shaft 74, an entrance rail 28 for the ceramic sheet to enter on the inner wall on the right side of the transmission cavity 27, and three display channels for displaying numerical values are provided on the front wall of the counting cavity 11. Hole 83, the device is provided with two counter dials 85 which count counterclockwise, one on the front end of the third transmission shaft 69, one on the fifth transmission shaft 71, and the first transmission shaft 67 A number plate 85 for counting clockwise is provided at the end of the front end, and the three are located on the same horizontal line.

According to the embodiment, the lifting mechanism 901 will be described in detail below. The lifting mechanism 901 further includes springs 18 which are symmetrically arranged on the lower side of the inclined platform 19 and are connected to the work platform 16.

According to the embodiment, the one-way bearing 902 is described in detail below. The one-way bearing 902 includes a bearing box 87 rotatably connected to the first transmission shaft 67. The bearing box 87 is provided with a rotation cavity 91, and the rotation The cavity 91 is provided with a roller 89 fixedly connected to the first transmission shaft 67. The roller 89 is provided with six bearing ratchets 90 distributed in an array, and the bearing box 87 is rotationally connected with six array distributed The thrust rod 86 is connected with a bearing spring 88 between the thrust rod 86 and the bearing box 87.

According to the embodiment, the determination component 903 will be described in detail below. The determination component 903 further includes a long rod 61 provided on the cable 58. A right side end of the slider 20 is provided with a horizontal bracket 59. A counting spring 60 is connected between the long rods 61.

According to the embodiment, the counting component 904 will be described in detail below. The counting component 904 further includes a semilunar 66 provided on the dot 13 and rotatably connected to the sheave 45. The sheave 45 is provided with A transmission slot 81 slidably connected to the dot 13.

Beneficially, when the counting lever 63 is in contact with the ratchet teeth 42, the ratchet teeth 42 can drive the counting lever 63 to rotate thirty-six degrees, which guarantees that when the toothed plate 44 rotates once, the counting ten times.

According to the embodiment, the resetting device 905 will be described in detail below. The resetting device 905 includes a resetting housing 50 provided on the lower wall of the counting chamber 11, and a resetting cavity 51 is provided in the resetting housing 50, and the resetting A bracket 49 is provided on the right wall of the cavity 51, and a reset spool 48 is provided on the bracket 49. A pressure spring 47 is provided between the reset spool 48 and the right wall of the reset cavity 51. A reset slideway 56 is provided on the left inner wall of the cavity 11, and a reset lever 55 is slidably connected to the reset slideway 56. A lever 52 is rotatably connected to the upper inner wall of the reset cavity 51, and the lever 52 and the reset cavity A return spring 53 is connected between the upper inner walls of the 51. The lever 52 is provided with a lever 54 rotatably connected to the reset lever 55 to change the position of the reset lever 55. The pressure spring 47 releases elastic potential energy, Implement the reset function.

According to the embodiment, the transmission assembly 906 will be described in detail below. The transmission assembly 906 includes an eighth transmission shaft 76 rotatably connected to the back wall of the counting chamber 11, and the eighth transmission shaft 76 is provided with a second auxiliary pulley. 37. A motor belt 39 is connected between the second auxiliary pulley 37 and the first main pulley 41. The eighth transmission shaft 76 is provided with a first A three-bevel gear 36, a ninth transmission shaft 34 is rotatably connected to the inner wall of the lower side of the counting chamber 11, and a ninth transmission shaft 34 is provided with a fourth bevel gear 38 meshed with the third bevel gear 36, The ninth transmission shaft 34 is provided with a second main pulley 33 located on the upper side of the fourth bevel gear 38. The ninth transmission shaft 34 is provided with a first main pulley 33 which is meshed with the first bevel gear 23. A five-bevel gear 22, a tenth transmission shaft 35 is rotatably connected to the inner wall of the lower side of the counting cavity 11, and a sixth bevel gear 30 is provided on the tenth transmission shaft 35 and can be meshed with the second bevel gear 82 A third auxiliary pulley 32 is disposed on the tenth transmission shaft 35 under the sixth bevel gear 30. The third auxiliary pulley 32 and the third auxiliary pulley 32 Two primary pulley 31 is connected between the belt 33.

According to the embodiment, the sequencing component 907 is described in detail below. The sequencing component 907 further includes an eleventh transmission shaft 73 rotatably connected to the rear wall of the transfer cavity 27. The eleventh transmission shaft 73 is provided with The fourth auxiliary pulley 26 is provided with a third main pulley 65 on the seventh transmission shaft 74. A transmission belt 29 is connected between the fourth auxiliary pulley 26 and the third main pulley 65. On the rear wall of the conveying cavity 27, a guide track 25 flush with the conveying belt 29 is provided. The guide track 25 is provided with twenty-two ball tracks 78 which are symmetrical in the front and rear. Rotating ball 79 which continuously adjusts the ceramic sheet to the position required for compounding.

The following describes in detail the use steps of a counting device on a ceramic chip assembly line in this article with reference to FIGS. 1 to 7:

Initial state: The counting lever 63 is vertically downward, the pressing spring 47 has no elastic potential energy, the counting lever 63 does not contact the ratchet teeth 42, and the numbers on the three digital discs 85 are “0”.

When the ceramic plate on the assembly line enters the guide rail 25 in the transfer cavity 27 from the entrance rail 28, the motor 77 is started to rotate the second transmission shaft 75 clockwise, and the ratchet teeth 42 are rotated clockwise by the disk 40 in turn, and Through the first main pulley 41, the motor belt 39, the second auxiliary pulley 37, the eighth transmission shaft 76, the third bevel gear 36, and the fourth bevel gear 38, the ninth transmission shaft 34 is driven to rotate, and then the fifth The bevel gear 22, the first bevel gear 23, and the sixth transmission shaft 72 drive the transmission wheel 24 to rotate counterclockwise, and pass the belt 31, the third auxiliary pulley 32, the tenth transmission shaft 35, the sixth bevel gear 30, and the second bevel gear. 82. The seventh transmission shaft 74 drives the third main pulley 65 to rotate counterclockwise, so that the upper surface of the transmission belt 29 moves from right to left, thereby driving the ceramic pieces to move to the storage slot 80 in turn to the left, and the transmission wheel 24 drives storage The ceramic plate in the slot 80 rotates counterclockwise and finally falls on the inclined table 19, and in turn, the counter lever 63 is brought into contact with the ratchet teeth 42 by the slider 20, the first transmission shaft 67, and the cable 58, and the spring 18 accumulates elastic potential energy. At this time, the ratchet teeth 42 can drive the counting lever 63 to rotate counterclockwise, so that The one-way bearing 902, the elastic belt 15, the first auxiliary pulley 43, and the toothed plate 44 drive the cable 58 to rotate thirty-six degrees counterclockwise. The single-digit value is increased by one. The counting disc 62 drives the long rod 61 counterclockwise. When rotating, the counting spring 60 accumulates the elastic potential energy. When the ceramic sheet slides out of the inclined table 19, the spring 18 releases the elastic potential energy, and then moves upward through the inclined table 19, the slider 20, the counting disc 62, and the counting lever 63. The lever 63 is not in contact with the ratchet teeth 42. The counting spring 60 releases the elastic potential energy, and in turn passes the long lever 61, the counting disc 62, and the counting lever 63 to restore the vertical state. When ten ceramic pieces fall into the inclined table 19, repeat The above steps, at this time, the toothed plate 44 and the ten-position gear 14 drive the cable 58 to rotate thirty-six degrees clockwise. The ten-digit value is increased by one. When one hundred ceramic pieces fall on the inclined table 19, the above steps are repeated. At that time, the cable 58 is rotated thirty-six degrees through the ten-position gear 14, the slot wheel 45, and the hundredth value is increased by one. At this time, the cable 58 in the reset spool 48 is wound into the hundred-level spool 84. The leaf spring 47 accumulates elastic potential energy. When the ceramic piece counting is completed, the reset lever 55 is pulled, and the lever 52 is sequentially rotated by the lever 54. At this time, the pressing spring 47 releases the elastic potential energy, so that all the cables in the hundred-bit spool 84 are wound into the reset spool 48. At this time, the tens and hundreds digits are reset to zero, and the inclined table 19 is manually pressed until the single digits are reset to zero. At the same time, the reset lever 55 is released, and all components are restored to the initial state, which is convenient for the next counting operation.

The beneficial effects of the present invention are: the present invention adopts a ball design to ensure that the position of the ceramic sheet meets the requirements when entering, uses a push rod and ratchet design to judge the placement of the ceramic sheet, and uses a one-way bearing to The direction of rotation is screened, so that only one motor is used as the power source, which saves components, adopts the intermittent cooperation between components, and realizes the counting function of singles, tens, and hundreds, using cables and coils. The design of the spring guarantees the function of numerical reset after the work is completed, and improves most of the current methods of counting the number of ceramic pieces are manually evaluated, which not only requires a lot of effort, but also has a large error in the statistical data.

In the above manner, those skilled in the art can make various changes according to the working mode within the scope of the present invention.

1. A counting device on a ceramic chip assembly line includes a casing, wherein the casing is provided with a counting cavity, a counting cavity is provided on the upper side of the counting cavity, and a working table is provided on the upper inner wall of the counting cavity; the table is provided with a lifting mechanism. The lifting mechanism includes a slider slidingly connected to the table, and an inclined table provided on the slider. A first transmission is rotatably connected to the lower side of the slider. Shaft, the first transmission shaft is provided with a cable, the first transmission shaft is provided with a one-way bearing located on the front side of the cable, and the back wall of the counting chamber is rotatably connected to the first transmission shaft A second transmission shaft below the transmission shaft; a judging component is provided on the back wall of the counting cavity, and the judging component includes a motor provided on the back wall of the counting cavity, a disc power-connected to the second transmission shaft, and a disc disposed on the disc. Ratchet teeth, a counting rod provided on the counting disc and capable of abutting the ratchet teeth, a rear wall of the counting cavity is rotatably connected with a transmission shaft located on the left side of the first transmission shaft, and the counting cavity A third transmission shaft located on the left side of the transmission shaft is rotatably connected to the rear wall, and a fourth transmission shaft located on the left side of the third transmission shaft is rotatably connected to the rear wall of the counting cavity. A fifth transmission shaft located on the left side of the fourth transmission shaft is rotatably connected to the transmission shaft. The transmission shaft is provided with a first auxiliary pulley, and the first auxiliary pulley is provided with a counting component. The counting component includes A toothed plate provided on the first auxiliary pulley, a ten-position gear provided on the third transmission shaft and capable of meshingly connecting with the toothed plate, provided on the fourth transmission shaft, and A gear meshed with the ten-position gear, a dot provided on the gear, to the fifth shaft and the sheave may be slidably connected to the dot; the lower wall of the counting chamber is provided with the reset device, the lower wall of the counting chamber is provided with a transmission component located on the right side of the reset device, and the rear wall of the transmission chamber is provided with a sequencing component. The sequencing component can be connected to the rear wall of the transmission cavity through a fifth transmission shaft, a transmission wheel provided on the fifth transmission shaft, and a storage slot provided on the transmission wheel.

2. The high-efficiency and environmental-friendly industrial acid sewage treatment equipment according to claim 1, characterized in that: an elastic belt is connected between the first auxiliary pulley and the one-way bearing, and the front end of the second transmission shaft A first main pulley is provided, a sixth transmission shaft is rotatably connected to the rear wall, a first bevel gear is provided at the front end of the sixth transmission shaft, and a seventh rotatably connected is provided on the rear wall of the transmission cavity. A transmission shaft, a second bevel gear is provided at the front end of the seventh transmission shaft, an entrance track for the ceramic sheet to enter on the inner wall on the right side of the transmission cavity, and three display through holes are provided on the front wall of the counting cavity, The device is provided with two counters for counting counterclockwise, one at the front end of the third drive shaft and one at the fifth drive shaft. The front end of the first drive shaft is provided with a clockwise count Digital disk.

3. The high-efficiency and environmentally-friendly industrial acid sewage treatment equipment according to claim 1, wherein the lifting mechanism further comprises springs arranged on the lower side of the inclined platform symmetrically and connected to the worktable.

4. The high-efficiency and environmental-friendly industrial acid sewage treatment equipment according to claim 1, wherein the one-way bearing includes a bearing box rotatably connected to the first transmission shaft, and a rotation cavity is provided in the bearing box. The rotating cavity is provided with a roller fixedly connected to the first transmission shaft, the roller is provided with six bearing ratchets distributed in an array, and the bearing box is rotationally connected with six thrusts distributed in an array. A bearing spring is connected between the thrust rod and the bearing box.

5. The high-efficiency and environmentally-friendly industrial acid sewage treatment equipment according to claim 1, wherein the determination component further comprises a long rod provided on the cable, and a horizontal bracket is provided at the right end of the slider, so that A counting spring is connected between the horizontal support and the long rod.

6. The high-efficiency and environmentally-friendly industrial acid sewage treatment equipment according to claim 1, wherein the counting component further comprises a semilunar wheel disposed on the dot and rotatably connected to the groove wheel, and The sheave is provided with a transmission groove which can be slidably connected to the round point.

7. The highly efficient and environmentally friendly industrial acid sewage treatment equipment according to claim 6, characterized in that when the counting lever abuts the ratchet teeth, the ratchet teeth can drive the counting lever to rotate 36 degrees.

8. The high-efficiency and environmentally-friendly industrial acid sewage treatment equipment according to claim 1, wherein the resetting device comprises a resetting housing provided on a lower wall of the counting cavity, and the resetting housing is provided with a resetting cavity therein. A bracket is provided on the right wall of the reset cavity, and a reset spool is provided on the bracket. A pressure spring is provided between the reset spool and the right wall of the reset cavity, and the left side of the counting cavity The inner wall is provided with a reset slide, a reset lever is slidably connected to the reset slide, a lever is rotationally connected to the upper inner wall of the reset cavity, and a reset spring is connected between the lever and the upper inner wall of the reset cavity. The lever is provided with a lever rotatably connected to the reset lever.

9. The high-efficiency and environmentally-friendly industrial acid sewage treatment equipment according to claim 1, wherein the transmission component comprises an eighth transmission shaft rotatably connected to the back wall of the counting chamber, and the eighth transmission shaft is provided with There is a second auxiliary pulley, a motor belt is connected between the second auxiliary pulley and the first main pulley, and the eighth transmission shaft is provided with a first A three-bevel gear, a ninth transmission shaft is rotatably connected to the inner wall of the lower side of the counting cavity, and a ninth transmission shaft is provided with a fourth bevel gear meshingly connected with the third bevel gear, and the ninth transmission shaft A second main pulley is located on the upper side of the fourth bevel gear, a fifth bevel gear is meshed with the first bevel gear on the ninth transmission shaft, and the inner wall of the lower side of the counting cavity is provided. A tenth transmission shaft is rotatably connected to the sixth transmission shaft. The tenth transmission shaft is provided with a sixth bevel gear that can be meshed with the second bevel gear. The tenth transmission shaft is provided with the sixth bevel gear. A third secondary pulley on the lower side, the third secondary pulley is connected to the second primary pulley There is a belt.

10. The high-efficiency and environmental-friendly industrial acid sewage treatment equipment according to claim 1, wherein the sequencing component further comprises an eleventh transmission shaft rotatably connected to the rear wall of the transfer cavity, and the eleventh A fourth auxiliary pulley is provided on the transmission shaft, and a third main pulley is provided on the seventh transmission shaft. A transmission belt is connected between the fourth auxiliary pulley and the third main pulley. A guide track that is flush with the transmission belt is provided on the rear wall of the transfer cavity. Twenty-two ball tracks are symmetrically arranged in the guide track, and rotatable balls are arranged in the ball track.
